(19) United States
(12) Patent Application Publication
(10) Pub. No.: US 2008/0135771 A1
(43) Pub. Date: Jun. 12, 2008

(54) Signal Discriminator for Radiation Detection System and Method

(75) Inventors: Viatcheslav Vydrin, Pittsburgh, PA (US); Robert K. Davis, Pittsburgh, PA (US); David S. Rundle, Butler, PA (US)

Correspondence Address: THE WEBB LAW FIRM, P.C., 700 KOPPERS BUILDING, 436 SEVENTH AVENUE, PITTSBURGH, PA, 15219, US

(73) Assignee: II-VI INCORPORATED, Saxonburg, PA (US)

(21) Appl. No.: 11/815,343

(22) PCT Filed: Mar. 7, 2006
(86) PCT No.: PCT/US06/08331

§ 371 Date: Aug. 2, 2007

Related U.S. Application Data
(60) Provisional application No. 60/660,382, filed on Mar. 10, 2005.

(51) Int. Cl. G01T 1/24

(52) U.S. Cl. 250/370.09

(57) ABSTRACT

A radiation detection system is operative for converting (1, 2) a radiation event into an electrical signal having an amplitude related to the energy of said radiation event, converting (3, 6) at least a portion of the electrical signal into a count value related to the amplitude of the electrical signal and determining (5) the energy of the radiation event from the count value.

### CROSS-REFERENCE TO RELATED APPLICATION

This application claims priority from U.S. Provisional Application No. 60/660,382, filed Mar. 10, 2005, which is incorporated herein by reference.

### BACKGROUND OF THE INVENTION

1. Field of the Invention

The present invention relates to radiation detection systems and gauges and, more particularly, to gamma and x-ray imaging systems.

2. Description of Related Art

Radiation detection systems and gauges have utilized analog signal amplification and shaping; counting; or analog-to-digital converters (ADCs) for many years. Typically, such devices count analog signals above a predetermined threshold or convert analog signal amplitude into a digital code for further processing.

In applications where multiple pixels must be used for capturing and processing very high radiation flux, growing complexity, size and cost of traditional systems have become a concern.

Heretofore, either high-speed ADCs; peak-detectors; or multiple comparators and digital-to-analog converters (DACs) were used for every pixel of an imaging system in order to discriminate analog signal amplitude. When scaled for multi-pixel arrays, however, such systems become expensive, bulky and power consuming.

It would, therefore, be desirable to overcome the above problems and others by providing an apparatus and method for signal discriminating in a radiation detection system that avoids the use of ADCs; peak-detectors; and/or multiple comparators and DACs.

### SUMMARY OF THE INVENTION

The invention is a radiation detection system. The system includes a radiation detector responsive to incident radiation for outputting a pixel signal having an amplitude related to an energy of said incident radiation; means for converting at least a portion of said pixel signal into a count value related to the amplitude thereof; and means for determining the energy of the incident radiation from the count value.

The means for converting can include a comparator for comparing the amplitude of the pixel signal to an amplitude of a threshold signal, said comparator having an output which is enabled in response to the amplitude of the pixel signal exceeding the amplitude of the threshold signal and which is not enabled in response to the amplitude of the pixel signal not exceeding the amplitude of the threshold signal; a clock oscillator for outputting clock pulses; and a counter for accumulating a count of clock pulses output by the clock oscillator when the output of the comparator is enabled, wherein said accumulated count of clock pulses is the count value.

The means for determining can include a controller, e.g., a digital signal processor (DSP) operative for receiving the count value from the counter. The controller is operative for associating the count value with one of a plurality of energy values related to the energy of said incident radiation.

The system can further include means for generating a pulse of predetermined amplitude and duration for processing into count data by the means for converting; and means for comparing the count data to predetermined count data for confirming the operation of the means for converting.

The invention is also a radiation detection method comprising (a) converting a radiation event into an electrical signal having an amplitude related to the energy of said radiation event; (b) converting at least a portion of said electrical signal into a count value related to the amplitude thereof; and (c) determining the energy of said radiation event from the count value.

Step (b) can include outputting clock pulses; comparing the amplitude of said electrical signal to a threshold signal; and accumulating a count of the clock pulses when the amplitude of said electrical signal bears a predetermined relation to said threshold signal, wherein the accumulated count of the clock pulses is the count value.

Step (c) can include comparing the count value to plural ranges of count values to determine in which range of count values the count value belongs, wherein each range of count values is related to a unique radiation event energy.

Lastly, the invention is a radiation detection system comprising a pixilated radiation detector having a plurality of pixels that are responsive to incident radiation for outputting a like plurality of pixel signals, each of which has an amplitude related to an energy of the radiation incident on the corresponding pixel; a clock outputting a series of pulses; means for comparing each pixel signal to a threshold signal; means for accumulating for each pixel a count of the pulses output by the clock when the means for comparing determines the corresponding pixel signal bears a predetermined relation to the threshold signal; and means for determining from the accumulated count of pulses for each pixel the energy of the radiation incident thereon.

The system can further include one or more of: means for generating a frame of the energy of the radiation determined to be incident on the plurality of pixels during a sample interval; means for amplifying and/or shaping each pixel signal prior to processing by the means for comparing; and means for outputting the threshold signal to the means for comparing.

The predetermined relation can be when the value of the pixel signal exceeds the value of the threshold signal.

The system can further include means for generating a pulse of predetermined amplitude and duration for processing into count data by the means for accumulating; and means for comparing the count data to predetermined count data for confirming the operation of the means for converting. A host computer can be provided for processing the frame of energy into an image.

### BRIEF DESCRIPTION OF THE DRAWINGS

FIG. 1 is a block diagram of a high-speed imaging system signal discriminator in accordance with the present invention; and

FIG. 2 is a timing diagram of the operation of the signal discriminator of FIG. 1.

### DETAILED DESCRIPTION OF THE INVENTION

The present invention is an apparatus and method for signal discrimination in a high-speed imaging or radiation detection system, such as, without limitation, a gamma camera or an x-ray imaging system.

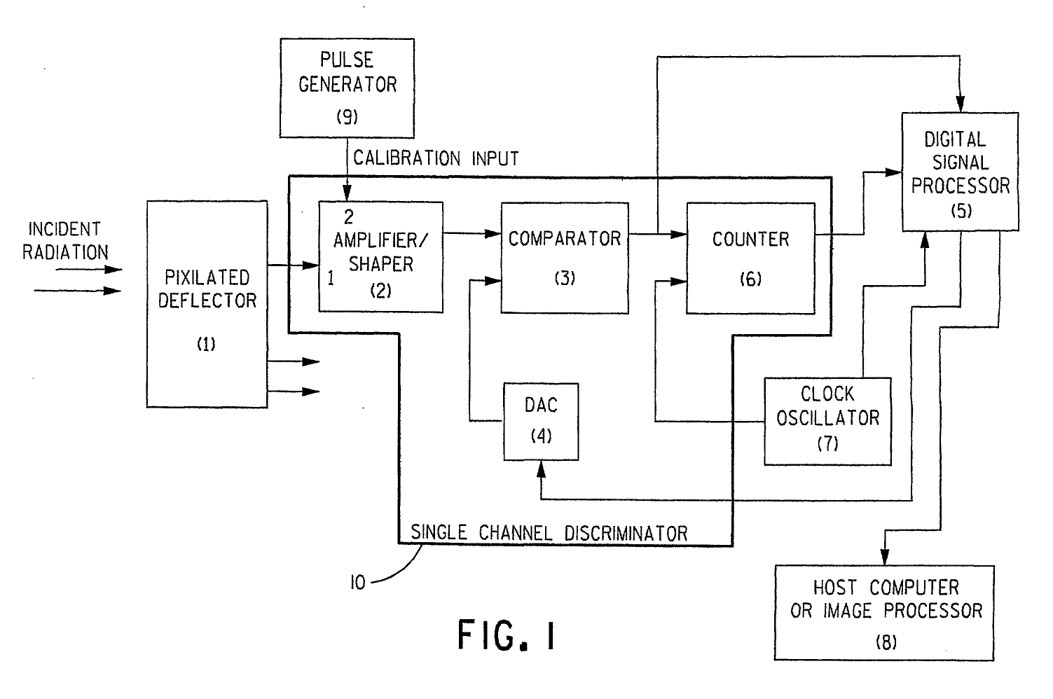

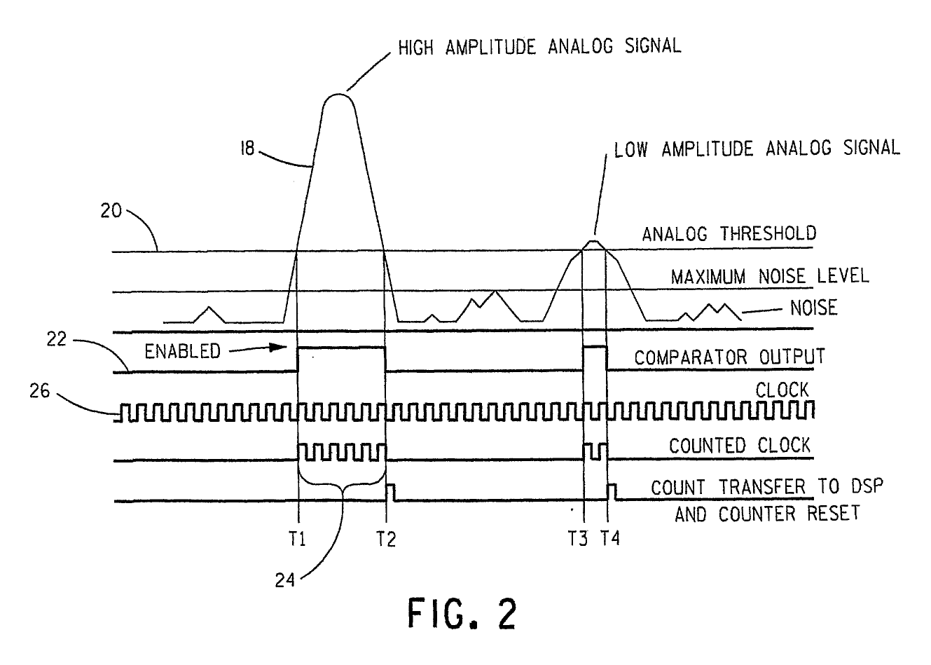

With reference to FIGS. 1 and 2, the apparatus includes a pixilated radiation detector 1 for outputting pixel signals related to the energy of photons received at the pixels thereof. More specifically, in response to receiving an incident photon, each pixel of pixilated detector 1 outputs a corresponding pixel signal to a discriminator circuit 10. While only one discriminator circuit 10 is shown in FIG. 1, it is envisioned that additional discriminator circuits 10 will be coupled to other pixels of pixilated detector 1 for processing pixel signals output thereby. Each discriminator circuit 10 may be configured to process the pixel signal output by one or more pixels of pixilated detector 1. For purpose of describing the present invention, it will be assumed that the discriminator circuit 10 shown in FIG. 1 is configured to process the pixel signal output by one pixel of pixilated detector 1.

Discriminator circuit 10 includes an amplifier/shaper circuit 2 for amplifying and shaping the pixel signal 18 output by the pixel of pixilated detector 1. The amplified and shaped pixel signal 18 output by amplifier/shaper circuit 2 is compared with a threshold signal 20 by a comparator 3 of discriminator circuit 10. Threshold signal 20 originates in a digital-to-analog converter (DAC) 4 of discriminator circuit 10 under the control of a digital signal processor (DSP) 5. Desirably, DSP 5 is not part of discriminator circuit 10 but, rather, is utilized with each discriminator circuit 10 of the apparatus. While shown as part of a single discriminator circuit 10, DAC 4 may be utilized to set the threshold signal for more than one comparator 3 of other discriminator circuits 10 if desired.

In response to the value of the amplified and shaped pixel signal 18 output by amplifier/shaper circuit 2 increasing above the value of the threshold signal 20 output by DAC 4 at a time T1, the output 22 of comparator 3 is enabled thereby enabling a counter 6 of discriminator circuit 10. While enabled by the output of comparator 3, counter 6 accumulates and outputs a count 24 of clock pulses 26 generated by a clock oscillator 7, which is desirably not part of discriminator circuit 10 but, rather, is utilized with each discriminator circuit 10 of the apparatus. The count 24 of clock pulses 26 accumulated and output by counter 6 is proportional to the time or duration counter 6 is enabled.

In response to the value of the amplified and shaped pixel signal 18 output by amplifier/shaper circuit 2 dropping below the value of the threshold signal 20 output by DAC 4 at a time T2, the output 22 of comparator 3 changes from its enabled state. In response to the output of comparator 3 changing from its enabled state, the accumulated count 24 of clock pulses 26 output by counter 6, i.e., the count value, is loaded into DSP 5 and the count 24 of clock pulses 26 accumulated by counter 6 is reset, desirably to zero (0), in preparation for counting the number of clock pulses occurring the next time the output of comparator 3 is enabled, e.g., between times T3 and T4 in FIG. 2.

Depending on the image collection and processing algorithm programmed and executed by DSP 5, the count value loaded into DSP 5 can be sorted thereby into one of a plurality of energy bins or values, each of which is related to a unique range of count values and, hence, energy of the radiation event corresponding to the pixel signal 18. The energy bin that the count value is sorted into can be accumulated, along with energy bins into which count values of other amplified and shaped pixel signals output by pixilated detector 1 during a particular sample interval, into a so-called frame of energy bins (or energy values) related to the amplified and shaped pixel signals output by pixilated detector 1 during said sample interval. This frame, and other frames accumulated during different sample intervals, can be transmitted from DSP 5 to a host computer 8 for further data processing and image reconstruction. Thus, each count value loaded into DSP 5 can be utilized to indirectly determine the height of the pulse output by amplifier/shaper circuit 2 and, therefore, the energy of the corresponding radiation event in the corresponding pixel of pixilated detector 1.

A pulse generator 9 can be connected to amplifier/shaper circuit 2 for proper system calibration. In operation, during calibration, a pulse of predetermined amplitude and duration is output by pulse generator 9 for processing by amplifier/shaper circuit 2, comparator 3 and counter 6 in the manner described above. Count data, corresponding to the pulse of predetermined amplitude and duration output by pulse generator 9, will be established and stored in DSP 5 or host computer 8. This count data can be checked against predetermined expected count data for the pulse of predetermined amplitude and duration output by pulse generator 9 to ensure the apparatus is operating properly.

As discussed above, the apparatus can be scaled for multi-pixel systems. To this end, clock oscillator 7, pulse generator 9, DSP 5 and host computer 8 can be connected in parallel to other discriminator circuits 10 for simultaneous count data collection and processing.

As can be seen, the present invention determines the time the amplified and shaped pixel signal 18 output by amplifier/shaper circuit 2 is above the value of the threshold signal 20 to indirectly determine the height of the amplified and shaped pixel signal 18 and, therefore, the energy of the corresponding radiation event in the corresponding pixel of pixilated detector 1. Measuring the energy of a radiation event in this manner reduces circuit complexity and component count allowing a smaller, lower power and less expensive apparatus for detecting the energy of radiation events in a radiation detector.

The present invention has been described with reference to the preferred embodiment. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A radiation detection system comprising:
a radiation detector responsive to incident radiation for outputting a pixel signal having an amplitude related to an energy of said incident radiation;
means for converting at least a portion of said pixel signal into a count value related to the amplitude thereof; and
means for determining the energy of the incident radiation from the count value.

2. The system of claim 1, wherein the means for converting includes:
a comparator for comparing the amplitude of the pixel signal to an amplitude of a threshold signal, said comparator having an output which is enabled in response to the amplitude of the pixel signal exceeding the amplitude of the threshold signal and which is not enabled in response to the amplitude of the pixel signal not exceeding the amplitude of the threshold signal;
a clock oscillator for outputting clock pulses; and
a counter for accumulating a count of clock pulses output by the clock oscillator when the output of the comparator is enabled, wherein said accumulated count of clock pulses is the count value.

3. The system of claim 2, wherein the means for determining includes a controller operative for receiving the count value from the counter.

4. The system of claim 3, wherein the controller is operative for associating the count value with one of a plurality of energy values related to the energy of said incident radiation.

5. The system of claim 1, further including:
means for generating a pulse of predetermined amplitude and duration for processing into count data by the means for converting; and
means for comparing the count data to predetermined count data for confirming the operation of the means for converting.

6. A radiation detection method comprising:
(a) converting a radiation event into an electrical signal having an amplitude related to the energy of said radiation event;
(b) converting at least a portion of said electrical signal into a count value related to the amplitude thereof; and
(c) determining the energy of said radiation event from the count value.

7. The method of claim 6, wherein step (b) includes:
outputting clock pulses;
comparing the amplitude of said electrical signal to a threshold signal; and
accumulating a count of the clock pulses when the amplitude of said electrical signal bears a predetermined relation to said threshold signal, wherein the accumulated count of the clock pulses is the count value.

8. The method of claim 7, wherein step (c) includes comparing the count value to plural ranges of count values to determine in which range of count values the count value belongs, wherein each range of count values is related to a unique radiation event energy.

9. A radiation detection system comprising:
a pixilated radiation detector having a plurality of pixels that are responsive to incident radiation for outputting a like plurality of pixel signals, each of which has an amplitude related to an energy of the radiation incident on the corresponding pixel;
a clock outputting a series of pulses;
means for comparing each pixel signal to a threshold signal;
means for accumulating for each pixel a count of the pulses output by the clock when the means for comparing determines the corresponding pixel signal bears a predetermined relation to the threshold signal; and
means for determining from the accumulated count of pulses for each pixel the energy of the radiation incident thereon.

10. The system of claim 9, further including means for generating a frame of the energy of the radiation determined to be incident on the plurality of pixels during a sample interval.

11. The system of claim 9, further including means for amplifying and/or shaping each pixel signal prior to processing by the means for comparing.

12. The system of claim 9, further including means for outputting the threshold signal to the means for comparing.

13. The system of claim 9, wherein the predetermined relation is when the value of the pixel signal exceeds the value of the threshold signal.

14. The system of claim 9, further including:
means for generating a pulse of predetermined amplitude and duration for processing into count data by the means for accumulating; and
means for comparing the count data to predetermined count data for confirming the operation of the means for converting.

15. The system of claim 10, further including a host computer for processing the frame of energy into an image.
